(19) United States
(12) Patent Application Publication
(10) Pub. No.: US 2006/0153078 A1
(43) Pub. Date: Jul. 13, 2006

(54) Receiver, transceiver, receiving method and transceiving method

(75) Inventor: Yoshiki Yasui, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/270,442

(22) Filed: Nov. 10, 2005

(30) Foreign Application Priority Data
Dec. 28, 2004 (JP) P2004-381785

(51) Int. Cl. H04J 1/16

(52) U.S. Cl. 370/235

(57) ABSTRACT

A receiver including: a receive buffer; a first buffer controller for deciding an initial value of capacity allocated to the receive buffer in accordance with each data type and updating the initial value of the allocated capacity in accordance with opening of the receive buffer; and a second buffer controller for dynamically updating either of the initial value of the allocated capacity and the allocated capacity after updating.

### CROSS-REFERENCE TO RELATED APPLICATION

This application is based upon and claims the benefit of priority from the prior Japanese Patent Application No. 2004-381785, filed on Dec. 28, 2004; the entire contents of which are incorporated herein by reference.

### BACKGROUND

1. Field

The present invention relates to a receiver, a transceiver, a receiving method and a transceiving method, for example, suitable for PCI Express Standard or the like to make high speed transmission possible.

2. Description of the Related Art

Apparatuses adapted to high speed data transmission have been developed in recent years. For example, in a computer system, PCI Express has been standardized as a high speed bus used for data transmission among a CPU, a memory, a graphic controller, a storage device and a peripheral device.

Generally, flow control is performed for ensuring data transmission between a transmitter and a receiver. Flow control is provided for deciding the quantity of data to be transmitted (transmission speed) in order to prevent a receive buffer from overflowing.

For example, JP-A-11-327938 has disclosed a method for dynamically performing flow control. In the method disclosed in JP-A-11-327938, flow control is performed in accordance with each application. That is, dynamic control is performed so that packets which will be received in the future are managed by each application to increase the capacity of the receive buffer allocated to an application protocol of high priority.

In the method disclosed in JP-A-11-327938, it is however necessary to support flow control for each application. Moreover, it is impossible to perform flow control in accordance with each data type such as each packet type, so that the buffer cannot be used efficiently.

On the contrary, in PCI Express Standard, the receive buffer is allocated in accordance with each packet type as described in PCI Express Base Specification 1.0a, PCI-SIG 2.6, Ordering and Receive Buffer Flow Control, pp. 100. In PCI Express Standard, information of capacity of the receive side buffer (receive buffer) allocated in accordance with each packet type (i.e. credit value) is compared with the quantity of transmitted data on the transmit side. That is, information of buffer capacity is first sent from the receive side to the transmit side to thereby initialize flow control on the transmit side. The transmit side judges whether data can be transmitted or not, on the basis of the comparison between the credit value and the quantity of data to be transmitted.

### BRIEF SUMMARY

The allocation of the receive buffer in accordance with each packet type, however, may be sometimes inappropriate. That is, there is some case where a relatively small capacity is allocated to a packet type relatively large in the quantity of data to be transmitted while a relatively large capacity is allocated to a packet type relatively small in the quantity of data to be transmitted. In this case, if flow control is performed in accordance with the initial value of the allocated capacity, it may be impossible to transmit data though there is a vacancy in the receive buffer. There is a problem that efficiency in use of the receive buffer is lowered.

The invention provides a receiver, a transceiver, a receiving method and a transceiving method in which the allocation of a receive buffer in accordance with each data type can be changed flexibly to improve efficiency in use of the receive buffer to thereby make data transmission more efficient.

### BRIEF DESCRIPTION OF THE DRAWINGS

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing a transceiver according to a first embodiment of the invention;

FIG. 2 is a flow chart showing flow control in a receiver;

FIG. 3 is a flow chart showing flow control in a transmitter;

FIG. 4 is a block diagram showing a second embodiment of the invention;

FIG. 5 is a flow chart for explaining the operation of the second embodiment;

FIG. 6 is a block diagram showing a third embodiment of the invention;

FIG. 7 is a flow chart for explaining the operation of the third embodiment;

FIG. 8 is a table for explaining the method for increasing/reducing the allocated capacity of a receive buffer on the basis of traffic statistics;

FIG. 9 is a table for explaining the method for increasing/reducing the allocated capacity of the receive buffer on the basis of traffic statistics;

FIG. 10 is a table for explaining the method for increasing/reducing the allocated capacity of the receive buffer on the basis of traffic statistics;

FIG. 11 is a block diagram showing a fourth embodiment of the invention;

FIG. 12 is a flow chart for explaining the operation of the fourth embodiment;

FIG. 13 is an explanatory view showing external appearance in the case where the transmitter and the receiver according to any one of the embodiments are incorporated in a computer; and

FIGS. 14A and 14B are explanatory views showing the hierarchical structure of the transmitter and the receiver according to any one of the embodiments in comparison with the hierarchical structure of PCI Express.

### DETAILED DESCRIPTION

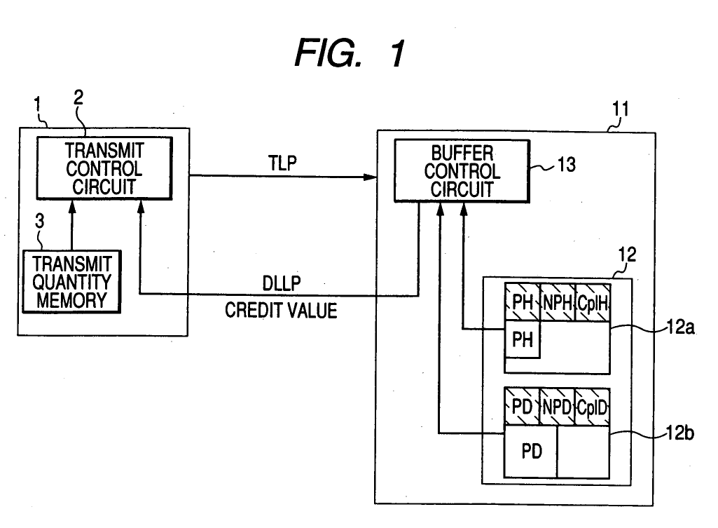

Embodiments of the invention will be described below in detail with reference to the drawings. FIG. 1 is a block diagram showing a transceiver according to a first embodiment of the invention. Although this embodiment is applied to PCI Express Standard, the invention can be applied to various systems for performing flow control on the transmit side in accordance with the vacant capacity of the receive buffer on the receive side.

For example, a transmitter 1 and a receiver 11 satisfy PCI Express Standard. The transmitter 1 is equivalent to a root complex in PCI Express Standard while the receiver 11 is equivalent to an end point in PCI Express Standard.

Incidentally, FIG. 1 shows only a configuration concerned with flow control for the transmitter 1 and the receiver 11. Illustration and description about a configuration for achieving other functions will be omitted here.

In architecture of PCI Express, there is provided a hierarchical structure composed of a transaction layer, a data link layer and a physical layer. The transmitter 1 transmits packets (transaction packets: TLPs) in the transaction layer located in the top-most position of the hierarchical structure. TLPs have three packet types, namely, Posted, Non-posted and Completion. Each TLP is formed from arrangement of a header and data. One of the three packet types is set in each of the header and data. That is, TLPs can have six data types.

In PCI Express, independent virtual communication paths called “virtual channels (VCs)” can be set. Independent receive buffers are set in the virtual channels respectively, so that flow control is performed independently. FIG. 1 shows the case where the receiver 11 has one virtual channel. In the case where the receiver has a plurality of virtual channels, the same configuration as in the receiver 11 shown in FIG. 1 is provided for each virtual channel.

The transmitter 1 can output TLPs of six data types in accordance with each virtual channel. For example, when the number of virtual channels is 8, the number of data types allowed to be output from the transmitter 1 is 48.

The receiver 11 receives TLPs from the transmitter 1. The receiver 11 has a receive buffer 12. The receive buffer 12 has a region 12a for storing headers included in the received TLPs, and a region 12b for storing data included in the TLPs. The region 12a contains a region PH for storing Posted type headers, a region NPH for storing Non-posted type headers, and a region CplH for storing Completion type headers. The region 12b contains a region PD for storing Posted type data, a region NPD for storing Non-posted type data, and a region CplD for storing Completion type data.

The receiver 11 is configured so that received data are stored in the regions of the receive buffer 12 respectively in accordance with the data types. The data stored in the receive buffer 12 are read out successively by an end point side software.

A buffer control circuit 13 which serves as first and second buffer controllers allocates respective sizes of the regions PH, NPH, CplH, PD, NPD and CplD in the receive buffer 12. That is, the buffer control circuit 13 allocates capacity in accordance with each data type. The capacity allocated in accordance with each data type is managed as the initial value of flow control by the buffer control circuit 13.

The buffer control circuit 13 is provided to transmit the capacity of the region allocated in accordance with each data type as an initial credit value to the transmitter 1. A packet (data link layer packet: DLLP) generated in the data link layer is used for transmission of the credit value.

When data stored in the receive buffer 12 are read out and the region of the receive buffer 12 is opened, the buffer control circuit 13 performs an updating process for increasing the credit value of the opened region by the opened capacity. The buffer control circuit 13 is provided to transmit the updated credit value to the transmitter 1.

The transmitter 1 receives the credit value transmitted by DLLP. The total quantity of data (the sum of consumed credit values) transmitted by the transmitter 1 is stored in a transmit quantity memory 3 of the transmitter 1. A transmit control circuit 2 compares the total quantity of transmitted data with the received credit value to thereby judge whether data is to be transmitted or not. That is, when there is some data to be transmitted to the receiver 11, the transmit control circuit 2 of the transmitter 1 compares the total quantity of already transmitted data with the credit value received from the receiver 11. The transmit control circuit 2 operates so that data to be transmitted is transmitted as TLP to the receiver 11 when the total quantity of transmitted data (the sum of consumed credit values) subtracted from the received credit value is larger than the quantity of data to be transmitted, and that data to be transmitted is not transmitted when the difference between the credit value and the sum of consumed credit values is smaller than the quantity of data to be transmitted.

In this embodiment, the buffer control circuit 13 is provided so that allocation of the receive buffer 12 into regions in accordance with data types can be changed. The hatched portions in FIG. 1 show the initial values of regions allocated in accordance with data types. An unhatched portion PH in the region 12a shows a region increased from the initial state for the data type PH. An unhatched portion PD in the region 12b shows a region increased from the initial state for the data type PD.

The buffer control circuit 13 calculates statistics for the data type of the received TLP, that is, traffic statistics. The buffer control circuit 13 makes a decision on the basis of the calculated traffic statistics as to whether the capacity of each region of the receive buffer 12 is to be increased or not, and as to the quantity of increase in capacity.

Whenever the capacity allocated to each region of the receive buffer 12 is changed, the buffer control circuit 13 updates the credit value in accordance with the size of the increased region and transmits the updated credit value to the transmitter 1. Incidentally, flow control is not applied to DLLP, so that DLLP can be always transmitted/received.

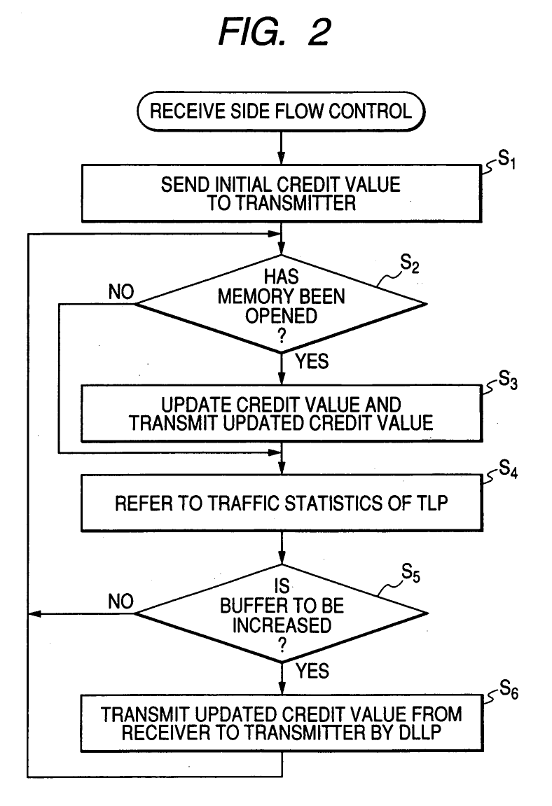

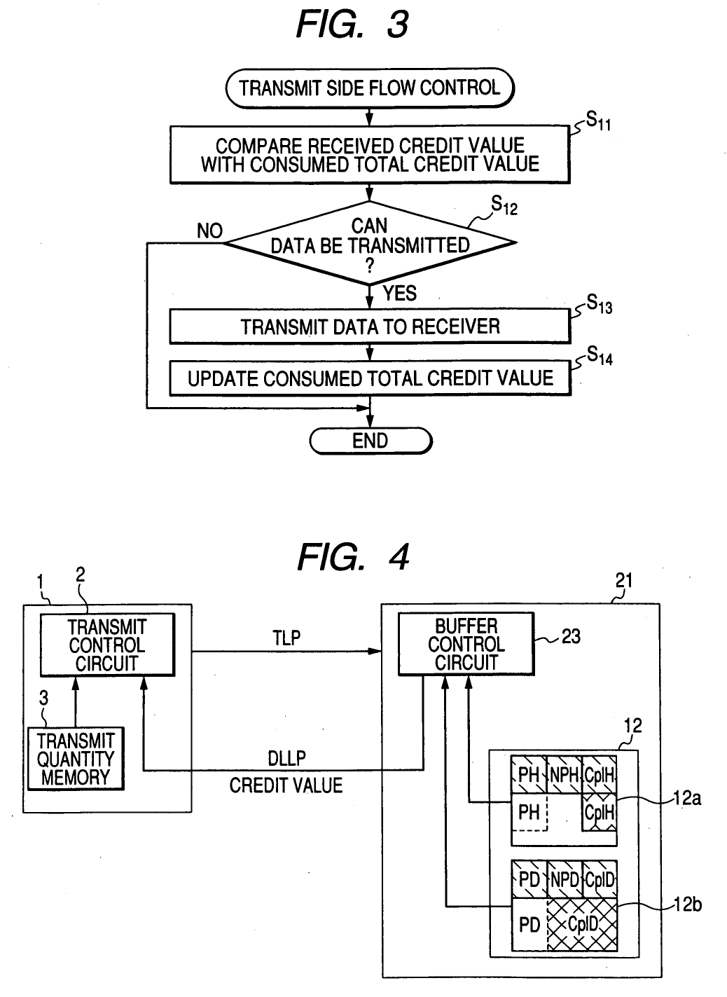

Next, the operation of the embodiment configured as described above will be described with reference to FIGS. 2 and 3 which are flow charts. FIG. 2 shows flow control in the receiver 11. FIG. 3 shows flow control in the transmitter 1.

At the time of initialization of flow control, the receiver 11 sets the minimum capacity required for data transmission from the transmitter 1 in the receive buffer 12. In this case, if the quantity of transmission in accordance with each data type can be predicted, the buffer control circuit 13 may set the credit value of a specific data type and the reserved region of the receive buffer to be larger than those of other data types in accordance with the prediction. The buffer control circuit 13 transmits the set initial credit value to the transmitter 1 by DLLP (step S1).

Here, assume that the transmitter 1 transmits predetermined TLP. For example, assume that the receiver 11 has a memory, so that the transmitter 1 transmits TLP to be written into the memory. The TLP to be written into the memory is a Posted type packet.

Just after initialization of flow control, there is no data stored in the receive buffer 12, so that the transmitter 1 can transmit TLP. When the transmitter 1 transmits TLP to be written in the memory, the total credit value consumed in the Posted type is increased by the quantity of transmitted data. The total credit value consumed is stored in the transmit quantity memory 3.

On the other hand, upon reception of the TLP from the transmitter 1, the receiver 11 increases the sum of the received Posted type credit values by the quantity of received data. Incidentally, the sum of the received credit values is equal to the sum of the consumed credit values on the transmit side. The sum of the received credit values is used for monitoring overflow etc. of the receive buffer 12. The TLP received in the receiver 11 is stored in the Posted type regions PH and PD in the receive buffer 12.

Moreover, assume that the transmitter 1 transmits TLP to be written in the memory. In this case, the transmit control circuit 2 of the transmitter 1 compares the credit value transmitted from the receiver 11 with the sum of the consumed credit values stored in the transmit quantity memory 3 (step S11). Data is transmitted when the sum of the consumed credit values subtracted from the received credit value is larger than the quantity of data to be transmitted, and data is not transmitted when the sum of the consumed credit values subtracted from the received credit value is smaller than the quantity of data to be transmitted (step S12).

Assuming now that (received credit value−the sum of consumed credit values)>(the quantity of data to be transmitted), then the transmitter 1 transmits the data to the receiver 11 (step S13). The transmit control circuit 2 generates the new sum of consumed credit values by adding the quantity of transmitted data to the sum of consumed credit values stored in the transmit quantity memory 3 (step S14).

On the other hand, the receiver 11 stores the received data in the storage region of a corresponding data type in the receive buffer 12. Here, assume that the data stored in the receive buffer 12 is read out by an end point side application. As a result, the corresponding region of the receive buffer 12 is opened so that data of a data type corresponding to the region can be stored. The buffer control circuit 13 updates the credit value of the corresponding data type by the vacant capacity due to reading when the buffer control circuit 13 makes a decision in the step S2 that the storage region of the receive buffer 12 is opened. The buffer control circuit 13 sends the increased credit value to the transmitter 1 by DLLP (step S3).

Updating the credit value and transmitting the updated credit value are performed whenever the storage region of the receive buffer 12 is opened due to reading of data from the receive buffer 12. Accordingly, the transmitter 1 can grasp the capacity of data allowed to be transmitted.

Here, assume that the receiver 11 increases the allocated capacity of a specific data type. For example, when lots of Posted type data are transmitted from the transmitter 1, the buffer control circuit 13 of the receiver 11 decides whether the capacity of the region PD for storing the Posted type data is to be increased or not (step S5), for example, by referring to traffic statistics of TLP (step S4). When the allocated region is increased, the buffer control circuit 13 updates the credit value by the increased capacity and sends the updated credit value to the transmitter 1 (step S6). Incidentally, the updated credit value may be sent at the same time when the credit value is updated in accordance with opening of the storage region of the receive buffer 12. That is, in this case, the credit value obtained by adding (a credit value corresponding to the opened storage region+a credit value corresponding to increase in allocation of the receive buffer) to the initial credit value is sent.

After that, the transmitter 1 can accordingly transmit a sufficient quantity of data to the receiver 11 with respect to the Posted type data. Similarly, the buffer control circuit 13 can increase the region (credit value) allocated to each data type as long as the capacity of the receive buffer 12 permits. Accordingly, for example, even in the case where the initial credit value in accordance with each data type cannot satisfy the quantity of data to be actually transmitted in accordance with each data type, the allocation in accordance with each data type can be changed dynamically to improve efficiency in use of the receive buffer 12.

As described above, in this embodiment, because the allocation of capacity of the receive buffer in accordance with each data type can be changed dynamically, efficiency in use of the receive buffer can be improved to attain higher data transmission speed.

For example, a small capacity is allocated to the receive buffer for each data type in advance so that a new capacity is reserved in the receive buffer on the basis of statistics of traffic actually flowing as TLP to thereby change the receive buffer dynamically. As a result, improvement in efficiency in use of the receive buffer can be attained to contribute to improvement in throughput. Incidentally, this embodiment can be achieved in the range of PCI Express Standard.

Although this embodiment has been described on the case where the transmitter 1 is equivalent to a root complex in PCI Express Standard while the receiver 11 is equivalent to an end point in PCI Express Standard, the root complex and the end point used actually can transmit data to each other and receive data from each other and have the same configuration as the transmitter 1 and the receiver 11.

FIG. 4 is a block diagram showing a second embodiment of the invention. In FIG. 4, the same constituent members as shown in FIG. 1 are denoted by the same reference numerals for the sake of omission of duplicated description. In the first embodiment, the allocated capacity of the receive buffer in accordance with data type can be increased. On the contrary, in this embodiment, the allocated capacity of the receive buffer in accordance with data type can be reduced.

This embodiment is different from the first embodiment in that a receiver 21 having a buffer control circuit 23 as first to third buffer controllers instead of the buffer control circuit 13 is used in this embodiment.

In PCI Express Standard, the initial credit value once set cannot be reduced because of its specification limit. Therefore, in this embodiment, the allocated capacity for a data type corresponding to the opened region can be reduced equivalently in such a manner that the credit value is not updated when the storage region of the receive buffer 12 is opened.

That is, the buffer control circuit 23 does not update the credit value for a data type as a subject of reduction of the allocated capacity even in the case where a corresponding region of the receive buffer 12 is opened due to reading of data stored in the receive buffer 12. Or the buffer control circuit 23 sets the credit value of the opened storage region for a data type as a subject of reduction of the allocated capacity to be zero or a capacity smaller than the opened capacity regardless of the opened capacity when the corresponding region of the receive buffer 12 is opened.

Incidentally, the process for increasing the allocated capacity of the receive buffer is the same as that in the first embodiment.

The other configuration is the same as in the first embodiment.

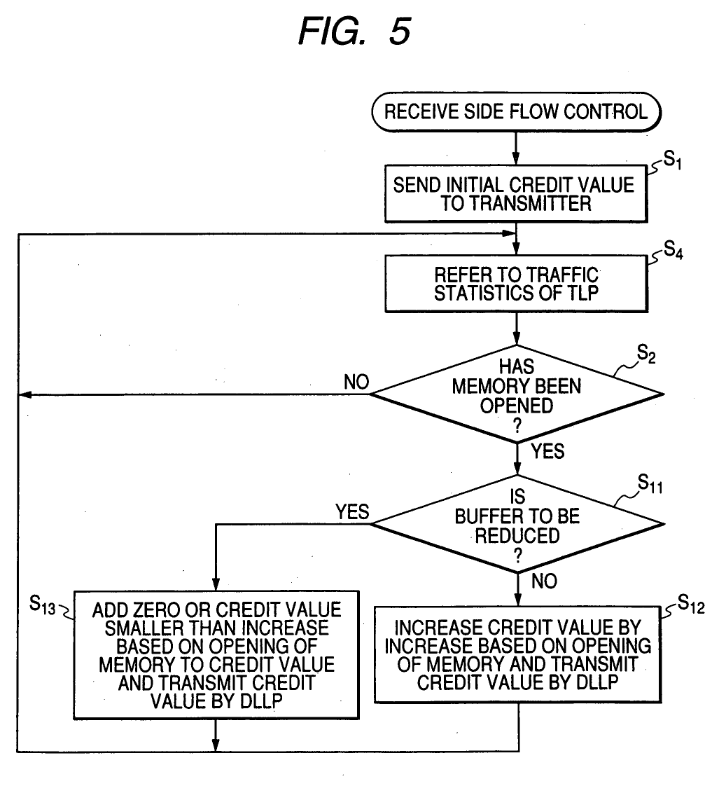

Next, the operation of the embodiment configured as described above will be described with reference to FIG. 5 which is a flow chart. In FIG. 5, the same steps as shown in FIG. 2 are denoted by the same reference symbols for the sake of omission of duplicated description.

Assume now that in step S2 shown in FIG. 5, data are read from a storage region of the receive buffer 12 so that the storage region of the receive buffer 12 is opened by the quantity of the read data. In the next step S11, the buffer control circuit 23 makes a judgment on the basis of traffic statistics as to whether the opened region corresponds to the data type allowed to reduce the allocated capacity or not. When the allocated capacity is not reduced, in the next step S12, the buffer control circuit 23 updates the credit value by adding the opened storage region's credit value. The updated credit value is transmitted to the transmitter 1.

As a result, in this case, the quantity of data allowed to be transmitted by the transmitter 1 is increased with respect to data of a data type corresponding to the opened region.

On the other hand, when the opened region corresponds to the data type allowed to reduce the allocated capacity, in step S13, the buffer control circuit 23 updates the credit value by adding a credit value smaller than the opened storage region's value or does not update the credit value by regarding the storage region as being unopened.

As a result, in this case, the quantity of data allowed to be transmitted does not change though the data is of a data type corresponding to the opened region. Moreover, because the region is opened, the opened region can be allocated to a region of another data type when the same buffer control as in the first embodiment is performed. Accordingly, the receive buffer 12 can be used more effectively.

In the example shown in FIG. 4, each hatched portion shows the initial value of a region allocated in accordance with each data type. The broken-line region PH in the region 12a shows a region reduced from the initial or preceding state for the data type PH. The broken-line region PD in the region 12b shows a region reduced from the initial or preceding state for the data type PD. The meshed regions in the regions 12a and 12b in FIG. 4 show regions increased from the initial or preceding state for the data types CplH and CplD.

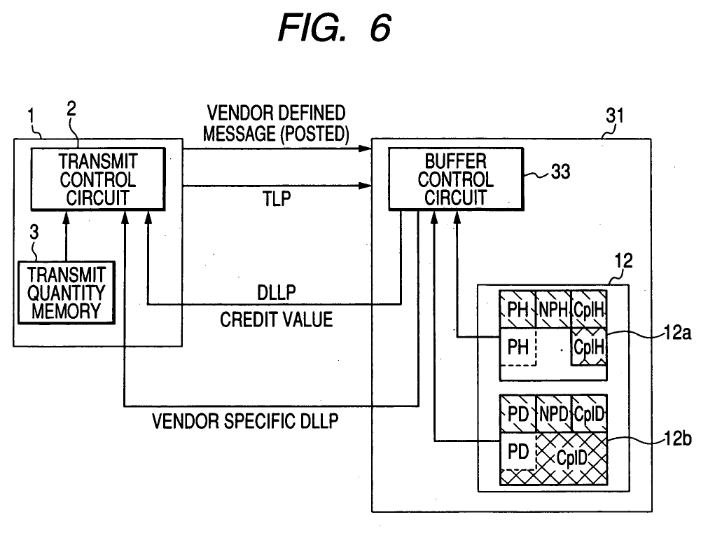

FIG. 6 is a block diagram showing a third embodiment of the invention. In FIG. 6, the same constituent members as in FIG. 4 are denoted by the same reference numerals for the sake of omission of duplicated description. In the second embodiment, the allocated capacity can be reduced equivalently in such a manner that the credit value is not updated when the receive buffer is opened. In the second embodiment, it is however possible to reduce the allocated capacity for only the data once received on the receive side and stored in the receive buffer. The possibility that data of the data type required to reduce the allocated capacity of the receive buffer will be transmitted as TLP from the transmitter 1 is however so low that there is little chance to reduce the allocated capacity of the receive buffer. Therefore, this embodiment makes it possible to reduce the allocated capacity of the receive buffer dynamically.

This embodiment is different from the second embodiment in that a receiver 31 having a buffer control circuit 33 instead of the buffer control circuit 23 is used in this embodiment.

In PCI Express Standard, it is possible to transmit TLPs having no influence on components (hereinafter referred to as “dummy TLPs”). The transmitter 1 can transmit such dummy TLPs to the receiver 31. The receiver 31 does not store the received dummy TLPs in the receive buffer 12 though the receiver 31 receives the dummy TLP.

That is, the buffer control circuit 33 of the receiver 31 does not increase the credit value of a corresponding data type even in the case where the region of the receive buffer 12 in which the dummy TLPs should be stored is actually opened. That is, in the transmitter 1 transmitting the dummy TLPs, the quantity of transmittable data with respect to the same data type as that of the dummy TLPs is reduced by the capacity of the dummy TLPs.

In this embodiment, to output the dummy TLPs from the transmitter 1, the buffer control circuit 33 of the receiver 31 transmits an instruction to the transmitter 1 so that the dummy TLPs corresponding to the data type as a subject of reduction of the allocated capacity of the receive buffer can be forcedly transmitted from the transmitter 1.

For example, this instruction is Vendor Specific DLLP. Information such as data type as a subject of reduction of the allocated capacity, header/data, VC and the quantity of reduction is stored in the DLLP. On the other hand, the transmitter 1 transmits TLPs of the data type as a subject of reduction of the allocated capacity of the receive buffer to the receiver 31 on the basis of the information of the Vendor Specific DLLP given from the receiver 31.

Incidentally, the process for increasing the allocated capacity of the receive buffer is the same as that in the first embodiment.

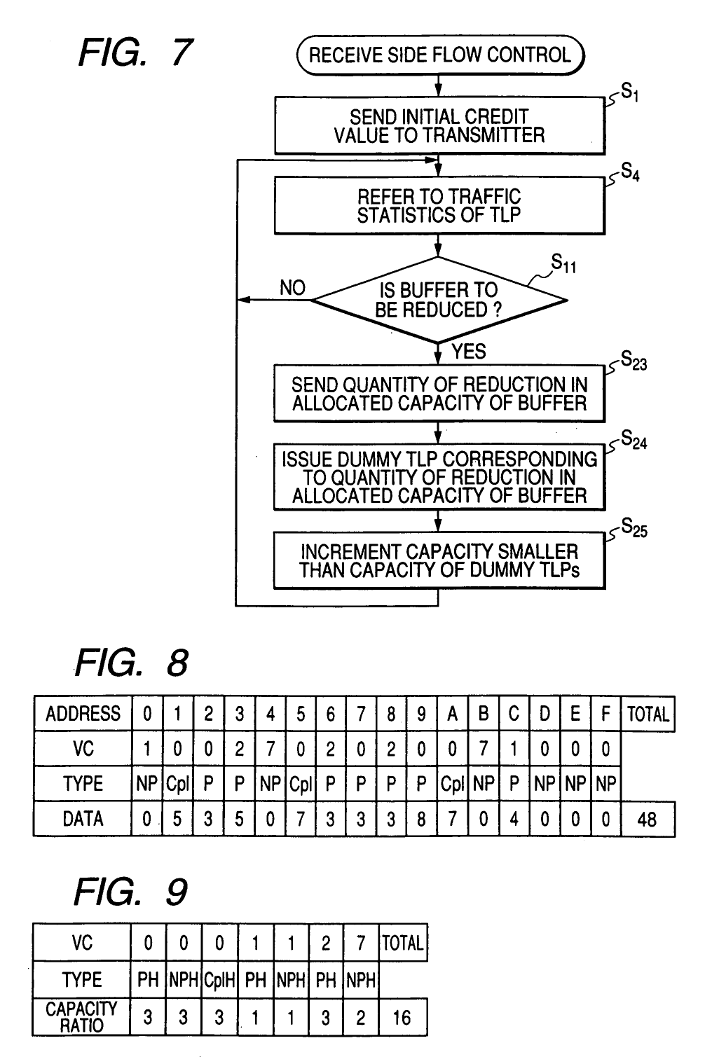

Next, the operation of the embodiment configured as described above will be described with reference to FIG. 7 which is a flow chart. In FIG. 7, the same steps as shown in FIG. 5 are denoted by the same reference symbols for the sake of omission of duplicated description.

In step S11 shown in FIG. 7, the buffer control circuit 33 makes a judgment on the basis of traffic statistics as to whether there is a data type as a subject of reduction of the allocated capacity or not. When there is a data type as a subject of reduction of the allocated capacity, in step S23, the buffer control circuit 33 sends an instruction to the transmitter 1 by using the Vendor Specific DLLP to transmit dummy packets of the data type as a subject of reduction. This instruction includes information concerned with the quantity of reduction of the allocated capacity.

Upon reception of the Vendor Specific DLLP, the transmitter 1 transmits dummy TLPs of the corresponding data type (step S24). As a result, with respect to the data type of the dummy TLPs, the consumed total credit value stored in the transmit quantity memory 3 is increased by the quantity of data of the dummy TLPs.

On the other hand, upon reception of the dummy TLPs, the buffer control circuit 33 of the receiver 31 does not update the credit value with respect to the data type of the dummy TLPs (step S25). That is, the total credit value consumed in the transmitter 1 is increased by the quantity of data of the dummy TLPs, whereas the credit value does not change though the receive buffer 12 is opened. Accordingly, the quantity of data which can be transmitted from the transmitter 1 is reduced equivalently with respect to data of the same data type as that of the dummy TLPs.

Incidentally, the buffer control circuit 33 may transmit the updated credit value by adding a capacity smaller than the quantity of data of the dummy TLPs to the credit value. Also in this case, with respect to data of the same data type as that of the dummy TLPs, the quantity of data which can be transmitted from the transmitter 1 is reduced.

Moreover, because the region is opened, the opened region can be allocated to a region of another data type when the same buffer control as in the first embodiment is performed. Accordingly, the receive buffer 12 can be used more effectively.

In the example shown in FIG. 6, each hatched portion shows the initial value of a region allocated in accordance with each data type. The broken-line region PH in the region 12a shows a region reduced from the initial or preceding state for the data type PH. The broken-line region PD in the region 12b shows a region reduced from the initial or preceding state for the data type PD. The meshed regions in the regions 12a and 12b in FIG. 6 show regions increased from the initial or preceding state for the data types CplH and CplD.

Incidentally, because the dummy TLPs must not be TLPs having influence on components, for example, it is preferable that Vendor Defined Message is used in the case of Posted credit. It is preferable that Memory Read Request or the like for an address region as having no influence is used in the case of Non-Posted credit.

In the example shown in FIG. 6, the transmitter 1 transmits data-including Vendor Defined Message to reduce the allocation of the region PD in which Posted type data is stored.

In PCI Express Standard, in the case of Completion credit, Completion type data without any request is not permitted. Therefore, in this case, the receiver 31 issues a specific Non-Posted type request to the transmitter 1 to generate Completion to thereby achieve reduction in allocated capacity actively. When a specific TLP such as a Non-Posted type request transmitted as dummy data is transmitted, it is preferable that the TLP is distinguished from other TLPs flowing in general traffic so as to be left out of consideration of traffic statistics of TLPs.

Incidentally, in each of the aforementioned embodiments, increase/reduction in allocated capacity of the receive buffer in accordance with each data type is performed on the basis of traffic statistics of transmitted TLPs. FIGS. 8 to 10 are tables for explaining the method for increasing/reducing the allocated capacity of the receive buffer on the basis of such traffic statistics.

Traffic statistics can be calculated from a receive history recorded in the receiver. FIG. 8 shows an example of traffic statistics recorded by use of an FIFO memory in the receiver. In the example shown in FIG. 8, the FIFO memory has sixteen regions of addresses 0 to F. Each region contains information such as virtual channel (VC), data type (Type) and data quantity (Data).

FIG. 9 shows the quantity of data in each header written into the region 12a of the receive buffer 12 at the timing that the information shown in FIG. 8 is held in the FIFO memory. In FIG. 9, data type (Type) and capacity ratio are shown in accordance with each virtual channel (VC). In PCI Express, one TLP contains one header, and at least one data. Accordingly, the capacity ratio in each header is equal to the number of data of each data type held in the FIFO memory.

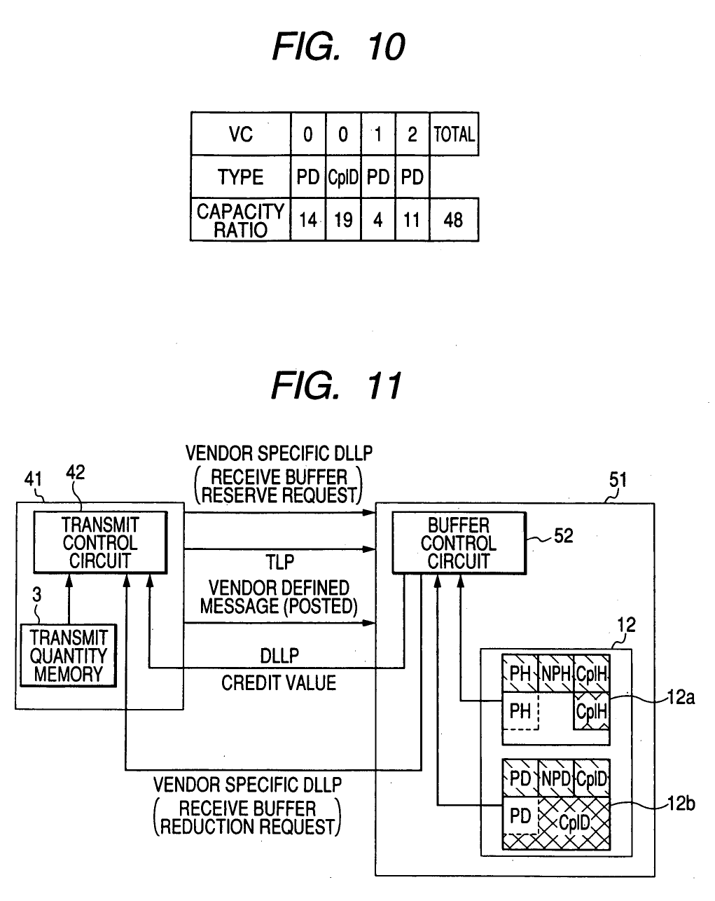

FIG. 10 shows the quantity of data written into the region 12b of the receive buffer 12 at the timing that the information shown in FIG. 8 is held in the FIFO memory. Also in FIG. 10, data type (Type) and capacity ratio are shown in accordance with each virtual channel (VC). With respect to data, the capacity ratio is the sum of the quantities of data of each data type held in the FIFO memory.

The buffer control circuit in the receiver decides increase/reduction in allocated capacity of the receive buffer 12 in accordance with each data type on the basis of the result of FIGS. 9 and 10. For example, the buffer control circuit allocates capacity in proportion to the capacity ratio shown in FIGS. 9 and 10. For example, as for a virtual channel (0), the capacity allocated to the region PD for storing Posted type data and the capacity allocated to the region CplD for storing Completion type data are decided to be at the rate of 14:19, based on the result shown in FIG. 10.

Incidentally, the buffer control circuit need not allocate capacity in proportion to the capacity ratio. The buffer control circuit may perform increase/reduction in buffer allocation actually while comparing the calculated receive buffer capacity ratio with the current buffer allocation.

Incidentally, because the receiver manages the receive buffer of TLPs, it is efficient to take statistics about TLPs received in the receiver.

As described above, because the allocated capacity of the receive buffer in accordance with each data type is updated in accordance with the trend of actual TLP traffic in any one of the aforementioned embodiments, efficiency in use of the receive buffer can be improved to enlarge throughput.

FIG. 11 is a block diagram showing a fourth embodiment of the invention. In FIG. 11, the same constituent members as shown in FIG. 6 are denoted by the same reference numerals for the sake of omission of duplicated description. In the third embodiment, dummy TLPs having no influence on components can be transmitted from the transmitter 1 so that increase/reduction in allocated capacity of the receive buffer 12 in accordance with each data type can be performed actively. Even in the case where the allocated capacity of the receive buffer is updated in this manner, there is however a possibility that transmission of TLPs will stop because the allocated capacity runs short (credit runs short) when burst access occurs suddenly.

Therefore, in this embodiment, the transmitter 1 gives an instruction such as Vendor Specific DLLP to the receiver to exclude the influence of the credit value so that the allocated capacity of the receive buffer can be forcedly changed.

This embodiment is different from FIG. 6 in that the transmitter 1 and the receiver 11 are replaced by a transmitter 41 and a receiver 51. For example, a transmit control circuit 42 of the transmitter 41 can transmit Vendor Specific DLLP to the receiver 51 in order to increase the allocated capacity of the receive buffer. Upon reception of the Vendor Specific DLLP, a buffer control circuit 52 of the receiver 51 preferentially reserves a storage region of the receive buffer 12 corresponding to the data type. The buffer control circuit 52 sends the updated credit value in accordance with the allocation of capacity to the transmitter 41.

Incidentally, the ordinary process for increasing the allocated capacity of the receive buffer 12 on the basis of traffic statistics and the process of reducing the allocated capacity of the receive buffer 12 are the same as those in the third embodiment.

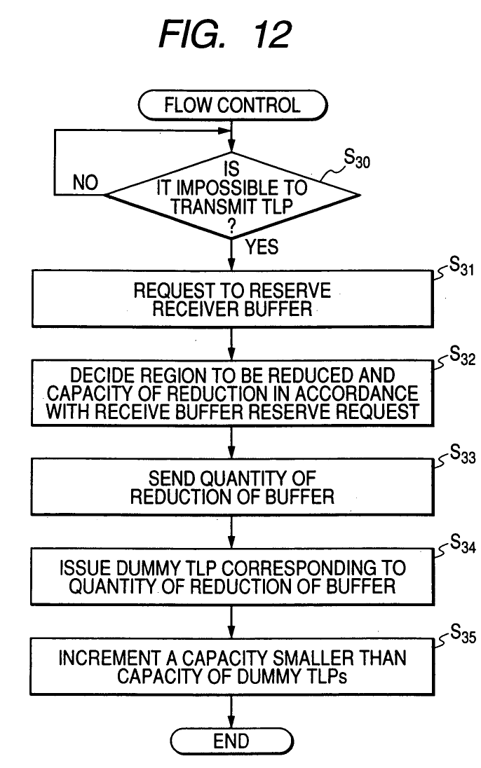

Next, the operation of the embodiment configured as described above will be described with reference to FIG. 12 which is a flow chart. In FIG. 12, the same steps as shown in FIG. 7 are denoted by the same reference symbols for the sake of omission of duplicated description.

Assume now that the transmitter 41 cannot transmit TLPs of Completion type data because of shortage of credit. In this case, the process goes from step S30 to step S31 in FIG. 12, so that the transmit control circuit 42 of the transmitter 41 transmits Vendor Specific DLLP to the receiver 51 to make a request to reserve the receive buffer.

The buffer control circuit 52 of the receiver 51 preferentially increases the allocated capacity of the region CplD for storing Completion type data in accordance with the received receive buffer reserve request. At the same time, the buffer control circuit 52 transmits Vendor Specific DLLP as a buffer reduction request of the Posted type data storage region to the transmitter 41 so that the allocation of the Posted type data storage region currently low in frequency in use can be changed to the allocation of the region CplD (step S32).

FIG. 12 shows an example in the case where the region in accordance with the receive buffer reserve request cannot be reserved in the receive buffer 12. In this case, the buffer is reduced before the reservation of the region.

The transmitter 41 transmits Vendor Defined Message as a dummy Posted message to the receiver 51 in accordance with the buffer reduction request (step S34). As a result, the buffer control circuit 52 of the receiver 51 reduces the Posted type data storage region (step S25).

As described above, in this embodiment, the allocation of the receive buffer for the data type short of credit can be forcedly increased from the transmitter side, so that the problem in disabled transmission of a specific TLP can be avoided. As a result, transaction latency of TLPs can be shortened to achieve efficient transmission.

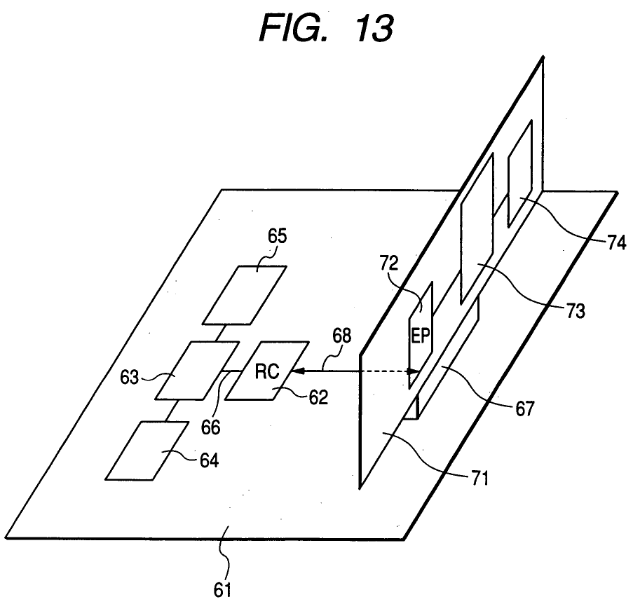

FIG. 13 is an explanatory view showing external appearance in the case where the transmitter and the receiver according to any one of the aforementioned embodiments are incorporated in a computer.

A root complex (RC) 62 equivalent to the transmitter according to any one of the aforementioned embodiments is formed as an IC chip mounted on a main board 61. A processor 63 provided as an IC, a memory controller 64, an I/O controller 65, etc. are disposed near the RC 62 and connected by a parallel or serial bus 66.

A port (not shown) of the RC 62 is connected to a slot 67 via a transmission path 68. An end point device 71 is connected to the slot 67. An end point (EP) 72 equivalent to the receiver according to any one of the aforementioned embodiments is mounted on the end point device 71. For example, when the end point device 71 is a graphic device, a graphic controller 73 and a graphic memory 74 are further mounted as well as the EP 72. Data transmission between the processor 63 and the graphic controller 73 is performed speedily and efficiently by the RC 62 and the EP 72.

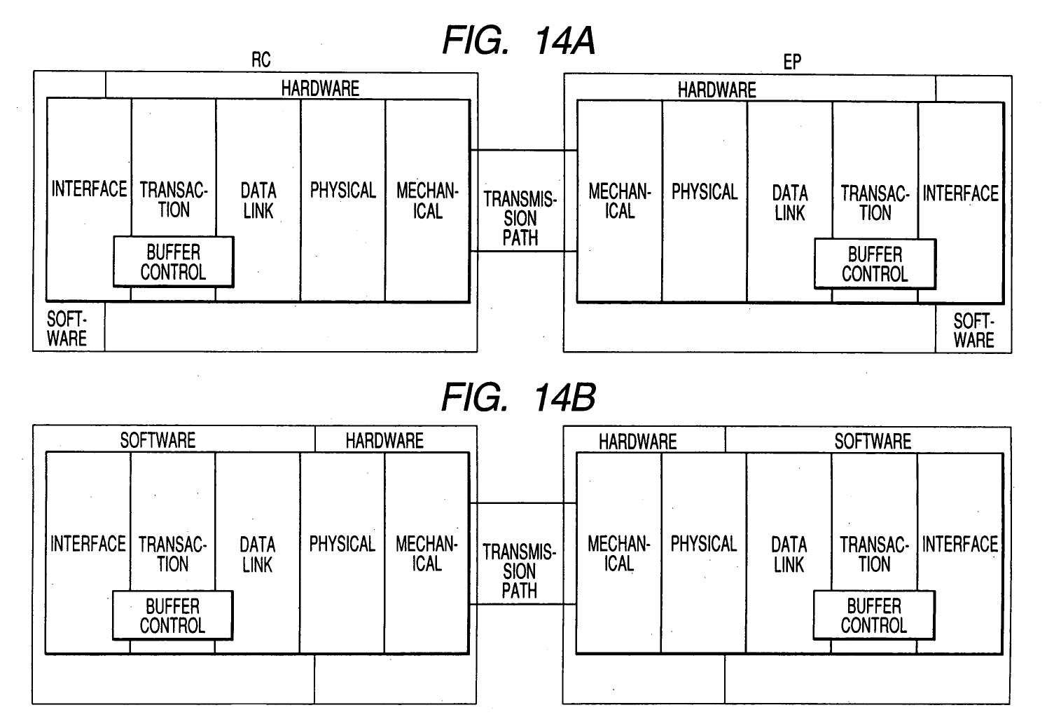

FIGS. 14A and 14B are explanatory views showing the hierarchical structure of the transmitter and the receiver according to any one of the aforementioned embodiment in comparison with the hierarchical structure of PCI Express.

In this embodiment, the hierarchical structure of from a mechanical layer and a physical layer as lower layers to an interface of applications as an upper layer is used like the hierarchical structure of PCI Express. Like mounting of a general system, software is often used for mounting the upper layer while hardware is often used for mounting the lower layer. As shown in FIG. 14A, also in this embodiment, a large part of the layers up to the application interface can be mounted as hardware.

As shown in FIG. 14B, it may be further conceived that only the lower layers up to the physical layer are mounted as hardware while all layers relevant to packet/protocol are mounted as software. The invention relates to layers before and after the transaction layer and mainly relates to buffer management of the transaction layer. In the example shown in FIG. 14A, buffer management in any one of the aforementioned embodiments is mounted as hardware. In the example shown in FIG. 14B, buffer management in any one of the aforementioned embodiments is mounted as software. That is, either the hardware mounting method or the software mounting method can be used in any one of the aforementioned embodiments.

What is claimed is:

1. A receiver comprising:
a receive buffer;
a first buffer controller for deciding an initial value of allocated capacity in the receive buffer in accordance with each data type and updating the initial value of the allocated capacity in accordance with opening of the receive buffer; and
a second buffer controller for dynamically updating either of the initial value of the allocated capacity and the allocated capacity after updating.

2. The receiver according to claim 1, wherein the second buffer controller dynamically updates the allocated capacity on the basis of traffic statistics in accordance with each data type.

3. The receiver according to claim 1, further comprising a third buffer controller for keeping the allocated capacity unchanged or increasing the allocated capacity by a smaller capacity than a capacity opened when the allocated capacity is updated in accordance with opening of the receive buffer by the first buffer controller.

4. The receiver according to claim 3, wherein the third buffer controller gives a command to a transmission side to transmit dummy data not accumulated in the receive buffer.

5. A transceiver comprising:
a receive side comprising:
a receive buffer;
a first buffer controller for deciding an initial value of allocated capacity in the receive buffer in accordance with each data type and updating the initial value of the allocated capacity in accordance with opening of the receive buffer; and
a second buffer controller for dynamically updating either of the initial value of the allocated capacity and the allocated capacity after updating; and
a transmit side comprising:
a transmit quantity storage unit for holding information concerned with a total quantity of transmitted data; and
a transmit controller for receiving information concerned with the capacity allocated in accordance with each data type in the receive buffer of the receive side and comparing the total quantity of data with the quantity of data to be transmitted to thereby decide whether the data to be transmitted can be transmitted or not.

6. The transceiver according to claim 5, wherein the receive side further comprises a third buffer controller which gives a command to the transmit side to transmit dummy data not accumulated in the receive buffer and which is provided for keeping the allocated capacity unchanged or increasing the allocated capacity by a smaller capacity than a capacity opened when the allocated capacity is updated in accordance with opening of the receive buffer by the first buffer controller, and
wherein the transmit side further comprises a dummy data transmitting unit for transmitting the dummy data.

7. The transceiver according to claim 6, wherein the transmit side further comprises a unit for issuing an instruction to increase the allocated capacity in accordance with each data type before the third buffer controller gives an instruction to the transmit side to transmit the dummy data.

8. A receiving method comprising:
deciding an initial value of allocated capacity in a receive buffer in accordance with each data type;
storing received data in a region of the receive buffer allocated in accordance with each data type;
updating the initial value of the allocated capacity in accordance with opening of the receive buffer; and
dynamically updating the initial value of the allocated capacity or the allocated capacity after updating.
